(19) United States
(12) Patent Application Publication
(10) Pub. No.: US 2015/0231509 A1
(43) Pub. Date: Aug. 20, 2015

(54) System, Method, and Apparatus for Smart Targeting

(71) Applicant: Xaviant, LLC (a GA Limited Liability Company), Cumming, GA (US)

(72) Inventors: Michael Parker McMain, II, Cumming, GA (US); Andrew William Thayer, Cumming, GA (US)

(21) Appl. No.: 14/181,895

(22) Filed: Feb. 17, 2014

(51) Int. Cl. A63F 13/837; A63F 13/55

(52) U.S. Cl. CPC A63F 13/837; A63F 13/55

(57) ABSTRACT

A gaming system in which a player is presented with multiple targets and, upon firing a trigger, the gaming system determines an intended target from the multiple targets and fires at the intended target without the need for crosshairs or reticules, etc. The intended target is algorithmically determined based upon, for example, distance (within the game space) from the player, angle with respect to the player, whether the target is an enemy, whether the target was recently fired upon, movement of the target with respect to the player, movement of the player, attributes of the target, etc.

### FIELD

This invention relates to the field of targeting and more particularly to a system for targeting an object within a video game.

### BACKGROUND

Video games for home use were first introduced in the early 1970's, most notably was a game called “Pong” that was an early arcade game that simulated a table tennis game. Each player had a simple rotating control that moved that player's paddle vertically on a screen to intercept a moving ball and redirect the ball towards the other player's side. In 1975, a famous video game manufacturer released a home version of Pong which had similar controls, but the playing field was displayed on a television.

Throughout the 1970's and 1980's the gaming industry saw substantial and profitable growth in game consoles. The late to mid-1990's and through-out the early twenty-first century the game industry has had incredible growth, both in profits as well as game console and/or computer system capabilities. The personal computer was responsible for some of this growth in gaming, but because the personal computer was designed for a broad set of intended uses, the personal computer hardware soon lagged behind the special purpose hardware of the dedicated gaming systems. Gaming consoles such as Microsoft's X-Box® and Sony's Playstation® provide the basis for game software to deliver realistic content. These platforms often include specialized hardware acceleration of typical mathematical and graphics functions that are often required by gaming software to provide realistic action and video.

Computer video games typically require input devices such as a controller to interact with the game. A game controller can be any input device used to control the video game, such as a keyboard or mouse, the more advanced games and gaming systems and consoles usually employ a gamepad, joystick, paddle, gesture detection devices, or any other specialized device designed for gaming, which receives physical input from the game player in control of said device. A game controller is typically used to govern the movement or actions of a player character (an avatar) within the video or computer game. This is most common in “Challenge-Type” games wherein the game is an obstacle course. In such, the game player controls the movements and actions of a player in a scenario, wherein the game controller, for example, permits the game player to choose and fire different weapons from a selection made available to the player by manipulating various buttons and switches on the controller. The player moves their character through a scene, firing the selected weapon against an enemy (typically a non-player character or an “NPC”) who is pitted against the game player as an adversary. The desired result (i.e., the “fun” of the game) is, for example, for the game player to traverse the obstacle course with his player character within the video game and arrive at an end point of safety, all the while using his skill in marksmanship and physical agility, albeit in a virtual world, to kill, wound or otherwise disable the enemy without the player's avatar getting seriously wounded or killed.

In Challenge-Type games, dialog, which permits some level of interaction or control between encountered characters, is almost non-existent as the purpose of the game (the “fun” or “interest” that is realized by the game player) is not to interact with others through narration, but instead is the thrill of killing or disabling your opponent before the opponent kills you.

“Narrative-Type” games typically have different intent, wherein the fun or interest for the game player is in the unfolding story and the drama component of the game. This is not to say that virtual physical encounters will not occur in Narrative-Type games, in that, some Narrative-Type games require the game player to incapacitate, injure or kill other characters that are encountered. It is just that the narrative portion and the drama component that surrounds a character encounter are more heavily weighted in the programming of the game. Since the game developer is trying to appeal to a different type of game player, game interaction and “aesthetics” of the game become more significant.

In video games, the player is often referred to as a “first person shooter,” in that, the person playing the video game by traversing the virtual world, often is the person who is shooting, casting spells, or any other form of performing damage on the various opponents, as those opponents are encountered. For example, the first person shooter has a firearm, a way of determining where the firearm is aiming, and a trigger such that, the first person shooter is able to aim and fire at the various opponents as they appear in the game's virtual world.

In prior art video games, the player typically has a reticule, sight, cross-hair, or any other type of indicator for providing feedback to the player as to where, for example, a bullet or spell will be directed when the player invokes a trigger to fire the bullet, spell, etc.

What is needed is a system that will determine a proper target based upon the player's intent.

### SUMMARY

In a gaming system, a player is presented with multiple targets and, upon firing a trigger, the gaming system determines an intended target from the multiple targets and fires at the intended target without the need for crosshairs or reticules, etc. The intended target is algorithmically determined based upon, for example, distance (within the game space) from the player, angle with respect to the player, whether the target is an enemy, whether the target was recently fired upon, movement of the target with respect to the player, movement of the player, attributes of the target, etc.

In one embodiment, a method for smart targeting in a video game operated in a virtual game space with a virtual viewport defining a local of a player of the video game is disclosed. At least a portion of the virtual viewport is displayed on a display device and the method includes steps of including a) providing at least two game characters within the virtual game space, and b) providing a player virtual location within the virtual viewport. c) A depiction of at least a portion of the virtual viewport is displayed on the display device. d) For each of the at least two game characters that are located within the virtual viewport, a target weight is calculated and the target weight is then associated with that game character. e) It is then determined which of the each of the at least two game characters that are located within the virtual viewport has the greatest weight. f) If a trigger has not been activated the above steps are repeated (steps c-f). If g) the trigger has been activated, firing at the game character that is located within the virtual viewport having the greatest target weight is initiated and steps c-g are repeated.

In another embodiment, a method for smart targeting in a video game operated in a virtual game space with a virtual viewport defining a local of a player of the video game is disclosed. At least a portion of the virtual viewport is displayed on a display device and the method includes steps of including a) providing at least two game characters within the virtual game space, b) providing a player virtual location within the virtual viewport, and c) providing a virtual area of focus within the virtual viewport. d) A depiction of at least a portion of the virtual viewport is displayed on the display device. e) For each of the at least two game characters that are located within the virtual area of focus, a target weight is calculated and the target weight is then associated with that game character. f) It is then determined which of the each of the at least two game characters that are located within the virtual area of focus has the greatest weight. g) If a trigger has not been activated the above steps are repeated (steps c-g). If h) the trigger has been activated, firing at the game character that is located within the virtual area of focus having the greatest target weight is initiated, and steps c-h are repeated.

In another embodiment, a computer-readable storage medium having embodied thereon a video game program operated in a virtual game space with a virtual viewport defining a local of a player of the video game is disclosed. At least a portion of the virtual viewport is displayed on a display device and the video game program is executable by a computing device for performing steps of including a) providing at least two game characters within the virtual game space, b) providing a player virtual location within the virtual viewport, and c) providing a virtual area of focus within the virtual viewport. d) A depiction of at least a portion of the virtual viewport is displayed on the display device. e) For each of the at least two game characters that are located within the virtual area of focus, a target weight is calculated and the target weight is then associated with that game character. f) It is then determined which of the each of the at least two game characters that are located within the virtual area of focus has the greatest weight. g) If a trigger has not been activated the above steps are repeated (steps c-g). If h) the trigger has been activated, firing at the game character that is located within the virtual area of focus having the greatest target weight is initiated, and steps c-h are repeated.

In another embodiment, a gaming system is disclosed including a computer that has a display, a trigger (e.g. a gesture or button on a controller), and a storage. A virtual game space is defined within the storage and a plurality of game characters are defined within the storage at game character locations within the virtual game space. A viewport that is a subset of the virtual game space is defined within the storage at a location within the virtual game space. Software instructions that are stored within the storage are executed by the computer to determine an intended target from the plurality of game characters, to detect activation of the trigger, and, responsive to activation of the trigger, to fire at the intended target (e.g. project an object at the intended target, cast a spell on the intended target, etc).

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a typical game scenario of the prior art.

FIG. 2 illustrates a second perspective view of a typical game scenario of the prior art.

FIG. 3 illustrates a perspective view of an exemplary game scenario with smart targeting.

FIG. 4 illustrates a second perspective view of an exemplary game scenario with smart targeting.

FIG. 5 illustrates a schematic view of an exemplary gaming system architecture.

FIG. 6 illustrates a schematic view of an exemplary gaming system virtual layout and viewport.

FIG. 7 illustrates a second schematic view of an exemplary gaming system virtual viewport.

FIG. 8 illustrates a schematic view of an exemplary gaming system data relationship.

FIG. 9 illustrates a first flow chart of an exemplary gaming system target selection.

FIG. 10 illustrates a second flow chart of an exemplary gaming system target selection.

FIG. 11 illustrates a third flow chart of an exemplary gaming system target selection.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In the following, the player is a person who is operating the game, typically the first person, perhaps in a first person shooter type of game. Throughout, the term “target” refers to a virtual object that generally is opposed to the player, e.g. an opponent or adversary. Targets are typically avatars of an enemy being, though targets are also known to be inanimate objects such as buildings, vehicles, aircraft, storage tanks, etc. Throughout, the term “projectile” represents any virtual object that is used as a weapon against a target, including, but not limited to, bullets, spells, rocks, fire, missiles, rockets, etc.

Typically, the player operates some type of controller (e.g. a keyboard, hand-held controller, joystick, etc.) while viewing the action and characters of the game on a display. During the game, the player virtually traverses a virtual game space that is, typically, laid out as a virtual world having scenery and, at some locations within the virtual world, characters, of which in some embodiments, some are friendly and some are unfriendly. Throughout this description, even though a real person is the player, reference to “the player” is synonymous to reference to the player's virtual self within the virtual game space. Therefore, a distance between the player and one of the characters is a distance between the player's virtual self and the character within the virtual game space, not a distance between the player (human) and the character within the virtual game space.

The player is presented with a subset of the virtual game space, typically on a monitor or any known display device. In such, the player is able to see a certain distance into the virtual game space, both side-to-side and forward. This area within the virtual game space in which the player can see is referred to as the virtual viewport.

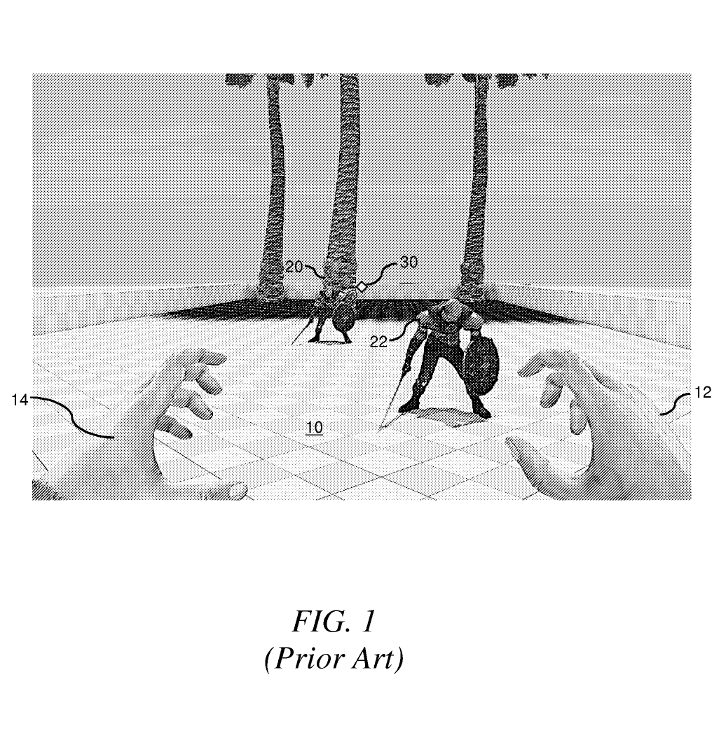

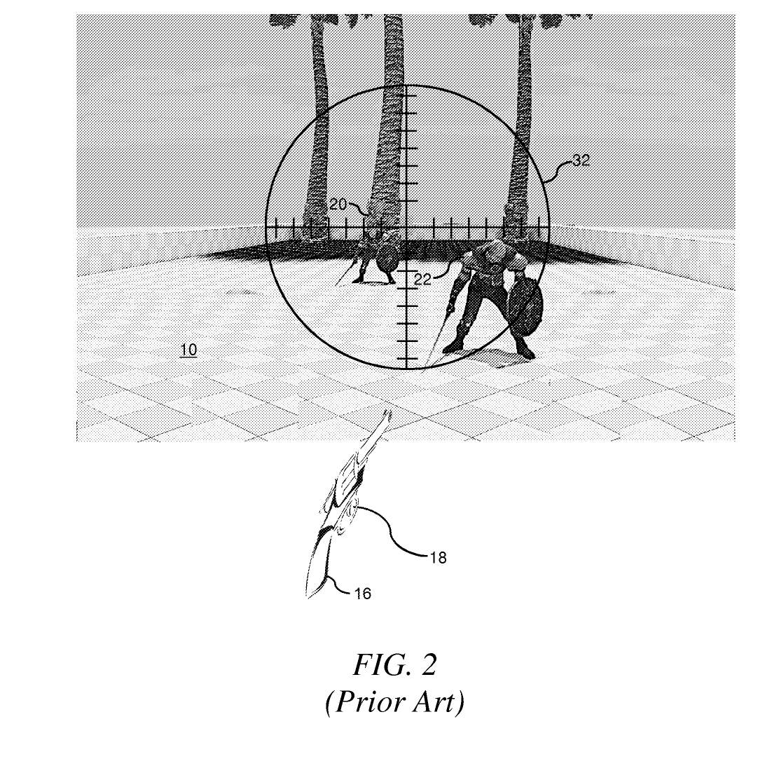

Referring to FIGS. 1 and 2, perspective views of typical game scenarios of the prior art are shown. In the prior art, the first person shooter, or player, must aim at an intended target 20/22, then invoke a trigger to attempt to inflict harm on the intended target 20/22 by, for example, shooting a weapon at the target 20/22, throwing something at the target 20/22, casting a spell on the target 20/22, etc. Typically, the player has positioning controls such as a joystick, left/right/up/down buttons on a game controller, or keyboard controls to effect location controls, often panning to the left or right. In FIG. 1, an icon-reticule 30 indicates the player's focus and is, in general, where the weapon (e.g., spell, bullet, grenade, etc.) will be targeted. In FIG. 1, the weapon is currently targeted at a distant wall and repositioning of the reticule 30 is needed to target one of the adversary elements 20/22 in the field 10 of the game (visual depiction of player's viewport). Also in the view of FIG. 1 are two hands 12/14 representing hands of the player for throwing objects or casting spells in the game.

Once the target 20/22 is acquired (e.g. positioned at the icon-reticule 30), invoking the trigger function initiates shooting, throwing, or casting a spell at that target 20/22, but there is no guarantee of a hit as the accuracy of the reticule 30 is often modified based upon projectile velocity (e.g. speed of a bullet or an arrow), virtual distance from the target 20/22, direction and speed of movement of the target 20/22, simulated wind, etc. Such firing often includes a visual depiction of an object (bullet, arrow, fireball, etc.) moving towards the target 20/22, then some change to the target 20/22 to indicate a hit by the object (e.g., for a fire ball, the target is engulfed in flames; for a spell, the target 20/22 changes color and clarity; for a bullet, the target 20/22 bleeds, etc.) and a result of the hit (e.g. the target 20/22 goes down, the target 20/22 burns, the target 20/22 freezes, etc.).

In FIG. 2, a similar game uses a crosshair-reticule 32 similar to that in a rifle scope. Again, once the target 20/22 is acquired (e.g. positioned at the intersection of the crosshair reticule 32), invoking the trigger function initiates shooting, throwing, or casting a spell at that target 20/22, as described above. In this example of the prior art, an icon of a gun 16 with a trigger 18 is shown, indicating that the player's trigger will initiate a launch of a bullet towards whatever target 20/22 is within the crosshairs 32.

Other similar target systems are known, including other reticules such as visual indicators (e.g. a color change, a red dot, or blurring at the targeted location) and/or audio indicators (e.g. a tone or beep that gets louder, changes tone, or beats faster when the target 20/22 is closer to the location at which the weapon is aimed), etc.

Again, in the typical game system, locating the reticle 30/32 over the target 20/22 and firing the trigger does not necessarily assure that the target 20/22 will be hit due to the speed of the player's selected projectile; direction, distance, and speed of the target 20/22; etc. Additionally, it is often difficult to position the reticule 30/32 over the target 20/22 due to target movement and precision of the player's controls. Some existing game technologies address this by providing features that move the reticule 30/32 to the closest target 20/22 or lock the reticule on a specific target. Additionally, some game systems automatically direct the projectile at the target 20/22 closest to the player's reticule 30/32.

Some existing game systems have reticule magnetism, in which the reticule/crosshair 30/32 is automatically pulled towards the target 20/22 nearest to the reticule 30/32, shortening the aim-fire ratio gap.

Some existing game systems have bullet magnetism, in which when the player fires while aiming the reticule 30/32 near enough to a target 20/22, the projectile(s) will go at the target 20/22 instead of where the reticule 30/32 is aimed.

Some existing game systems have a lock-on feature invoked by an input method triggers a lock-on; the reticule 30/32 automatically shifts to the nearest target 20/22, possibly allowing the player to aim at specific parts of the target.

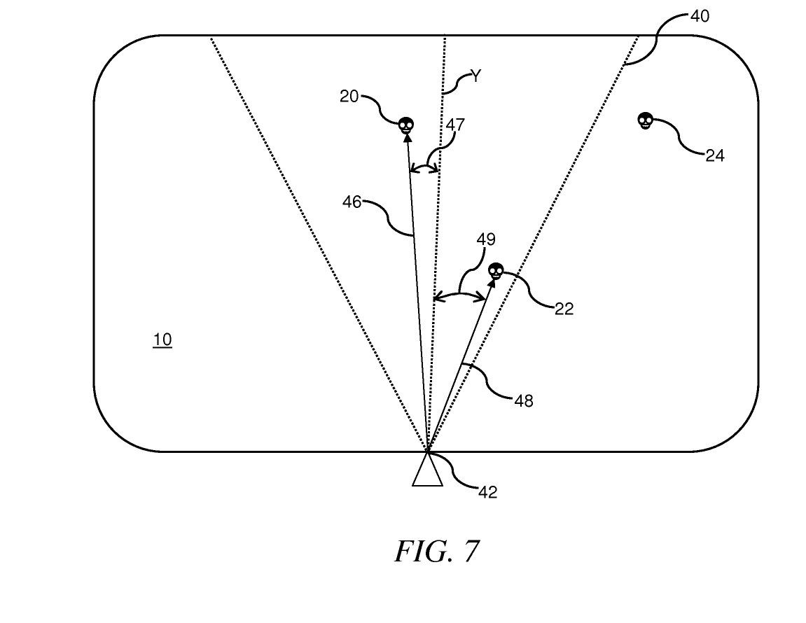

As an example, in a gaming system that has no active aiming, in the examples of FIGS. 1 and 2, if the player fires the weapon (e.g. shoots, casts a spell, etc.), the projectile fires at the point of the reticule 30/32 and misses both targets 20/22. If the gaming system has active aiming, the gaming system selects the target 20/22 that is closest to the reticule 30/32 (in virtual space), and the projectile fires at the left target 20 that is closest to the reticule 30/32. In either case, the wrong target (left target 20) is selected when the right target 22 (closest to the player virtual location 5—see FIG. 7) is likely to be a greater priority to the player.

All of these systems have several things in common: they employ a visual and/or audio aid (reticule 30/32); and they all assist in aiming at a specific target. It is generally understood from the prior art that a visual or audio reticle is used to play a first-person shooter game.

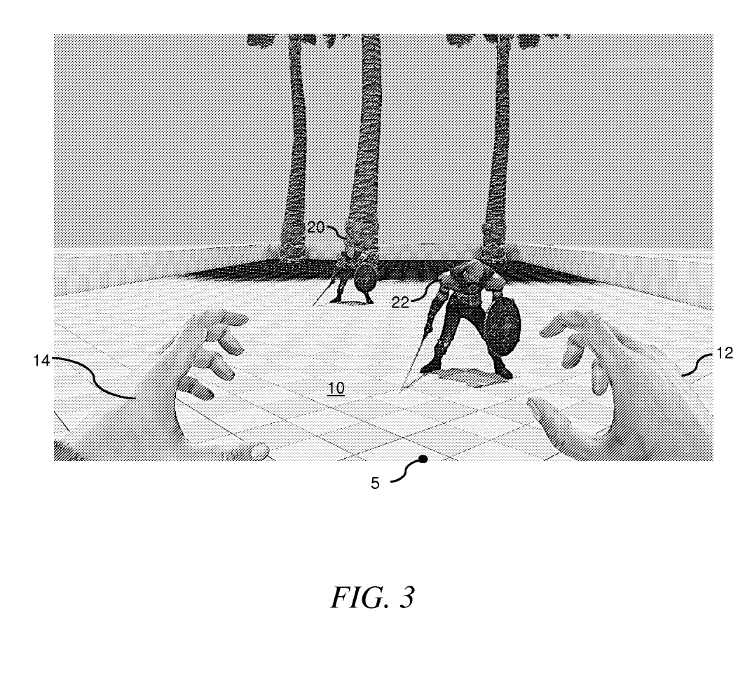

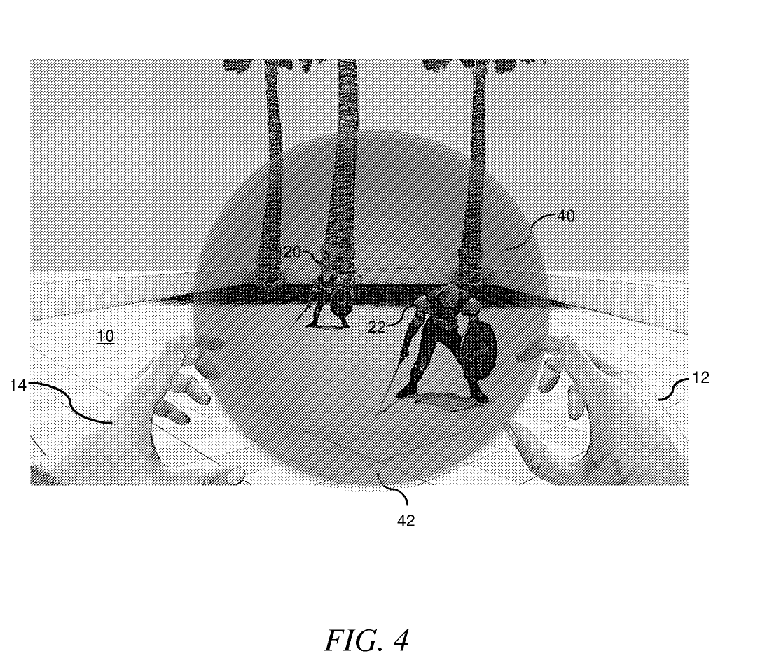

Referring to FIGS. 3 and 4, perspective views of an exemplary game scenario with smart targeting are shown. In the Smart Targeting system, there is no (or little) need for any audio and/or video reticules 30/32 as in the prior art as shown in FIGS. 1 and 2. The Smart Targeting system operates based upon player intent and, therefore, does not require the use of a reticule. A screen view of what the player would see is shown in FIG. 3. In one embodiment, the Smart Targeting system uses player intent to select a target 20/22 from the target(s) 20/22 within the viewport 10. The Smart Targeting system employs algorithms that examine all possible targets 20/22 that are, for example, visible within the viewport 10, select the most desirable target 20/22, aim at the selected target 20/22, and fires at the selected target 20/22.

As will be described, a weight is calculated for each available target 20/22 (an available target is, for example, targets 20/22 that are within the viewport 10 so targets outside of view are not evaluated). The weight is based on, for example, the angle of the target 20/22 relative to the player's virtual position 5 (in the virtual world, generally the center of the viewport 10 at the center of the display), the virtual distance of the target 20/22 from the player's virtual position 5 (in the virtual world), and whether the target was recently determined to be the “best” target. The target 20/22 having the highest weight out of all the possible targets 20/22 is then deemed the “best” target 20/22 and activation of a trigger (e.g. firing a weapon, casting a spell, etc.), will direct the object of the activation at the target 20/22 that was deemed the “best” target 20/22, without the use of any audio and/or visual reticle.

Smart Targeting algorithms calculate weights for each of the targets 20/22 based upon one or more criteria. Examples of these criteria are, not limited to, the angle of the target 20/22 relative to the center of the viewport, the virtual distance of the target 20/22 from the player (in the virtual world), whether the target was recently determined to be the “best” target, a direction of movement of the target 20/22, a danger-factor of the target 20/22, a type of weapon possessed by the target 20/22, etc. For simplicity, the examples described here within will calculate each weight based upon the angle, distance, and recent “best target.” Therefore, in the example of FIG. 3, the closer target 22 receives the highest weight. Firing of the weapon (or casting the spell) results in the projectile (or spell) aimed at the closer target 22.

In some embodiments of smart targeting games in which the player casts spells, the player does not employ a weapon, per se, but instead uses magical spells. In such, the smart target determination is periodically calculated to select the “best” target 20/22 until the player casts a spell, at which time that target 20/22 is locked as the “current target” until the spell effect is released (e.g. time lapses or the player releases the spell), at which time the smart targeting system resumes periodic calculations to select the “best” target 20/22. By periodic, any repeat frequency is anticipated ranging from continuous based upon the limitations and computational load of the gaming system to pre-determined repeat frequency such as every 1/10^{th} of a second, etc. It is also anticipated that the calculation of “best” target 20/22 be performed each time the trigger is activated.

In FIG. 4, another weighting factor is shown. In this example, a cone 40 emanates from a cone origin 42 which is the same location 5 as the player's virtual position (or coordinates within the virtual space of the game). In this example, the cone 40 is three dimensional, although a two-dimensional triangle or any other shaped area is also anticipated. The cone 40, as viewed from the players perspective, is depicted as a circular object 40 due to the inability to see the third dimension in the view of FIG. 4. In a preferred embodiment, the cone 40 is not displayed on the player's display device while in other embodiments the cone 40 is displayed in translucent or almost transparent colors and/or textures so as to not impede view of other scenery and characters. An angle of the edges of the cone 40 from the cone origin 42 is from zero to 90 degrees, for example, 23 degrees. The cone 40 has a fixed length of some number of units that are meaningful within the game such as 50 (e.g., 50 paces, 50 feet, 50 meters, 50 miles, etc.). In this example, all targets 20/22 determined to be within the cone 40 are considered.

As an example, a first weight for each target 20/22 within the cone 40 is calculated based upon the distance between that target 20/22 and the cone origin 42. A second weight for each target 20/22 is calculated based upon the angle between the target 20/22 and the cone origin 42. The first weight and the second weight are combined (e.g. multiplied or added to/by each other) and, if the target 20/22 was recently acquired, the combined weight is multiplied by an enhancement constant (e.g. 3) to calculate an overall weight for each target 20/22. The target 20/22 with the highest overall weight is selected and, if the player invokes a trigger, that target 20/22 with the highest overall weight becomes the receiver of whatever object is launched by the trigger (e.g. a spell, bullet, etc.). In this example and without any prior actions, the closest target 22 will have the highest weight and, therefore, will receive the object (e.g. bullet, spell, etc.).

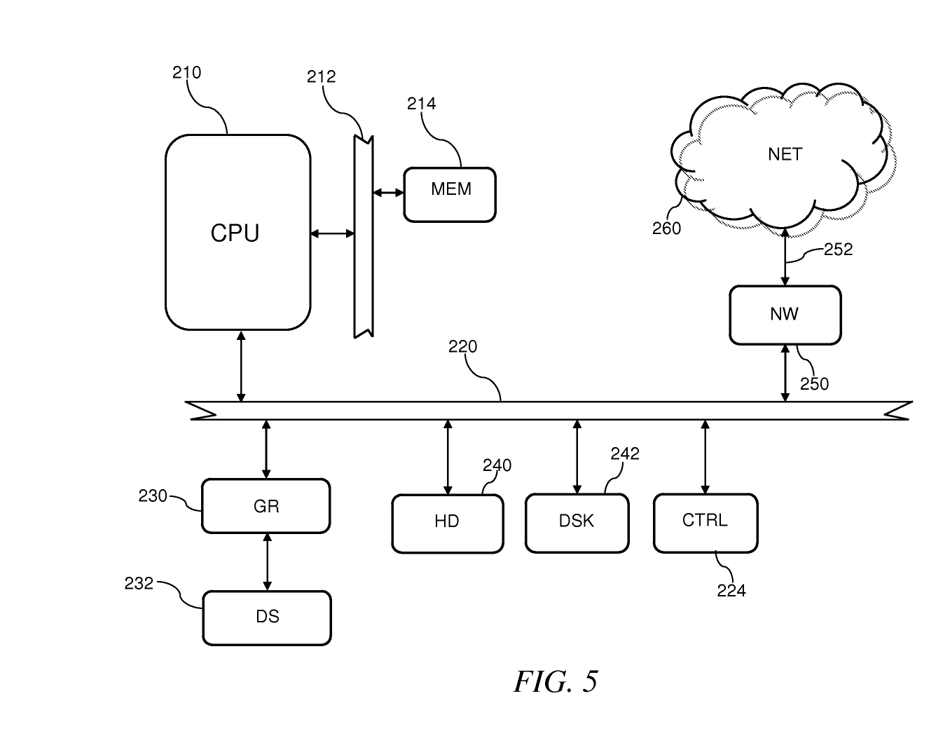

Referring to FIG. 5, a schematic view of an exemplary computer-based gaming system architecture is shown. The exemplary computer-based gaming system represents one such typical computer system used for gaming, many other systems and architectures are anticipated. The example computer-based gaming system is shown in its simplest form, having a single processor. Many different computer-based gaming architectures are known that accomplish similar results in a similar fashion and the present invention is not limited in any way to any particular computer-based gaming system. The present invention works well utilizing a single processor system as shown in FIG. 5, a multiple processor system where multiple processors share resources such as memory and storage, an array of cell processors, etc. In the example of a computer-based gaming system shown, a processor 210 executes or runs stored programs that are generally stored for execution within a memory 214. The processor 210 is any processor or a group of processors, for example an Intel Pentium-4® CPU or the like. The memory 214 is typically connected to the processor by a memory bus 212 and is any memory 214 suitable for connection with the selected processor 210, such as SRAM, DRAM, SDRAM, RDRAM, DDR, DDR-2, etc. Also connected to the processor 210 is a system bus 220 for connecting to peripheral subsystems such as a network interface 250, storage 240, a disk drive (e.g. DVD, CD) 242, a graphics adapter 230 and one or more keyboards or game controllers 224. The graphics adapter 230 receives commands and display information from the system bus 220 and generates a display image that is displayed on the display device 232. In some embodiments, to improve graphics performance, the graphics adapter has direct access to the memory 214 or has access to the memory bus 212 as known in the industry.

In general, the storage device 240 (e.g. hard disk, flash memory, etc.) is used to store programs, executable code and data persistently, while the disk drive 242 is used to load CD/DVD/Blu-ray disks having programs, executable code and/or data. These peripherals are examples of input/output devices, persistent storage and removable media storage. Other examples of persistent storage include core memory, FRAM, flash memory, etc. Other examples of removable media storage include CDRW, DVD, DVD writeable, Blu-ray, compact flash, other removable flash media, floppy disk, ZIP®, etc. In some embodiments, other devices are connected to the system through the system bus 230 or with other input-output connections/arrangements as known in the industry. Examples of these devices include printers; graphics tablets; joysticks; and communications adapters such as modems and Ethernet adapters.

In some embodiments, a network interface 250 connects the computer-based system to the network 260 through a link 252 which is, preferably, a high speed link such as a cable broadband connection, a Digital Subscriber Loop (DSL) broadband connection, a T1 line or a T3 line. In such, the network interface 250 is used to share portions of an operating game with other players, share data, share virtual game space, tokens, game pieces, game monetary instruments, high score data, download game programs, segments, updates, and many other uses.

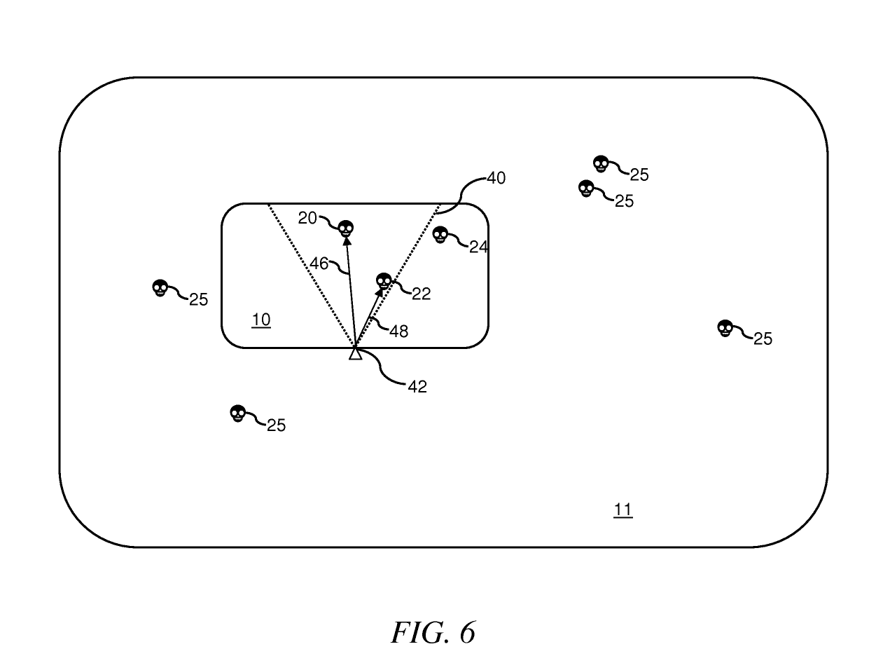

Referring to FIGS. 6 and 7, schematic views of an exemplary gaming system virtual game space 11 and viewport 10 are shown. The gaming virtual game space 11 shown in FIG. 6 is greatly simplified over any virtual layout used in an anticipated game for reasons of brevity and clarity. This exemplary gaming virtual game space 11 is shown only in two dimensions (X and Y) while it is understood that many modern gaming systems operate in three dimensions (X, Y, and Z). Also, the exemplary gaming virtual game space 11 shows the player's viewport 10, the virtual cone (virtual area of focus) 40, and an assortment of targets (opponents) 20/22/24/25. Some of the targets 20/22/24 are within the player's viewport 10 and other targets 25 are outside of the player's viewport 10 (e.g. not within view of the player on the display 232).

As in the prior examples, in some embodiments, only targets 20/22 within the cone 40 are evaluated as potential targets, while in some embodiments, all targets 20/22/24 within the player's viewport 10 are evaluated as potential targets.

As in the prior examples, the distance from the cone origin 42 (e.g., the player position within the virtual game space) to each target 20/22 is calculated. A first distance 46 from the cone origin 42 to a first target 20 and a second distance 48 from the cone origin 42 to a second target 22 are calculated. Using the two-dimensional example, the first distance 46 is calculated in game units from the coordinates (X, Y) of the cone origin 42 to the coordinates of the first target 20 and the second distance 48 is calculated in game units from the coordinates (X, Y) of the cone origin 42 to the coordinates of the second target 22. Next, the angle from the cone origin 42 to each target 20/22 is calculated. A first angle 47 from the cone origin 42 to a first target 20 and a second angle 49 from the cone origin 42 to a second target 22 are calculated. Using the two-dimensional example, the first angle 47 is calculated in degrees from a vertical axis (Y) of the cone 40 to the coordinates of the first target 20 and the second angle 49 is calculated in degrees from the vertical axis (Y) of the cone 40 to the coordinates of the second target 22. As will be shown, these distances 46/48 and angles 47/49 are used to determine which one of the targets 20/22 within the cone 40 is the intended target 20/22.

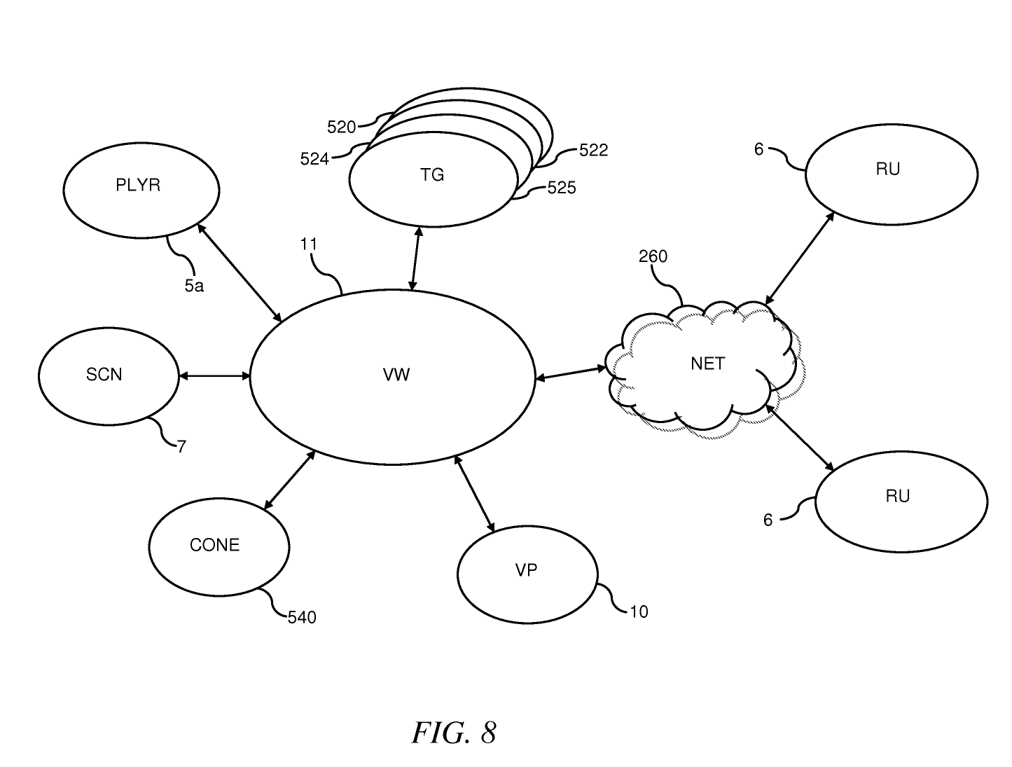

Referring to FIG. 8, a schematic view of an exemplary gaming system data relationship is shown. Again, this is a simplified example of one particular data relationship and many other data relationships are anticipated. In modern gaming, a virtual game space 11 is typically defined as the space in which a player and other objects can roam. As the player roams through the virtual game space 11, the player is presented with a visual representation of a portion of the virtual game space 11 on, for example, the display device 232. That portion of the virtual game space 11 is the player's viewport 10.

Representations in the virtual game space 11 have units of measurement that are defined by the gaming system that may or may not relate to real objects. For example, in one model, a width of a doorway is 350 distance units which does not necessarily relate to an actual width of any real doorway. Of course, virtual objects that must pass through this doorway need be less than 350 distance units wide, etc.

In the exemplary relationship of FIG. 8, the virtual game space 11 is a data structure that includes elements related to the size (e.g. rectangular area for a 2-dimensional model) of the virtual world. In this example, the total width (X) and depth (Y) when looking at the virtual gaming space from above is stored in this data structure for the virtual game space 11.

The virtual viewport 10 is a data structure that includes elements related to the size and location of the virtual viewport 10 within the virtual game space 11. As the player traverses the virtual world (e.g. by invoking movement controls on the control device 224), the coordinates (X, Y) of the virtual viewport 10 are updated and any objects visible within the virtual viewport 10 are presented on, for example, the display device 232. Typically, the coordinates (X, Y) of the virtual viewport 10 are the coordinates of the cone origin 42.

The player element 5a (single player is shown for simplicity) is a data structure that includes elements related to the player such as current strength, direction of movement, direction of view within the virtual world, current weapons, current ammunition, maximum speed, etc. In the examples shown, the player's location within the virtual world is the same as the coordinate of the virtual viewport 10.

To make games realistic and interesting, complex scenery is often included having buildings, landscape, hills, mountains, rocks, streams, oceans, animate objects, animals, etc. For simplicity, the list of such objects and interaction of such objects with the player and targets 20/22/24/25 are not described (e.g., the targets 20/22/24/25 are able to hide behind a building). Such scenery and background is represented by scenery data 7 and not fully described here within for brevity and clarity reasons.

The cone 40 has a data structure 540 that includes, for example, coordinates of the cone origin 42, the angle of expansion of the cone 40 from the cone origin 42 (e.g. the cone expands at an angle of 23 degrees from the cone origin 42) and the cone depth in distance units, representing the overall depth of the cone from the cone origin 42. In some scenarios, only targets 20/22/24/25 that are within the cone 40 are considered when determining an intended target.

For each target 20/22/24/25, a target data structure 520/522/524/525 includes, for example, coordinates of the associated target 20/22/24/25, identification of the associated target 20/22/24/25, direction and speed of movement of the associated target 20/22/24/25, strength of the associated target 20/22/24/25, etc. Note, only four target data structure 520/522/524/525 are shown for simplicity, though any number of target data structures 520/522/524/525 is anticipated.

In some embodiments, the gaming system is connected to one or more remote gaming systems 6 through, for example, a computer network 260. In such embodiments, it is anticipated that multiple remote players 6 exist, each having data structure elements representing that remote player's avatar (e.g., coordinates, virtual viewport, strength, etc.). The complexities of such are not described for clarity and brevity reasons.

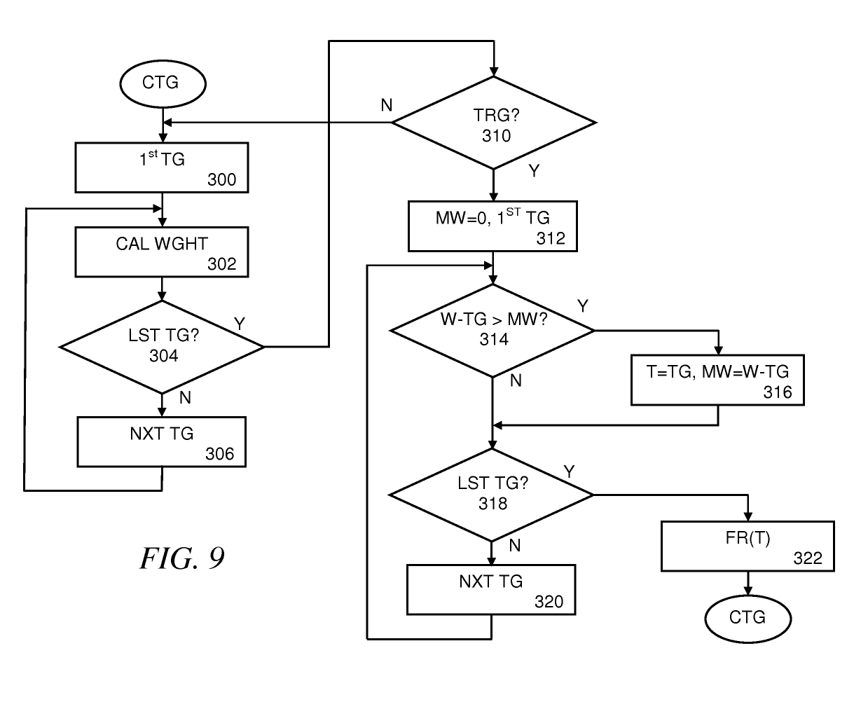

Referring to FIG. 9, a first flow chart of an exemplary gaming system target selection is shown. Again, note that this is an exemplary program flow and there are many other program flows anticipated that will achieve similar results in similar or different manners.

The calculation is performed periodically (as shown in FIG. 9) or upon initiation of a trigger. For simplicity, the periodic calculation is shown and described. In this, there are many targets 20/22/24/25, typically in a data structure such as an array or linked list so that the first and subsequent targets 20/22/24/25 are exhaustively locatable.

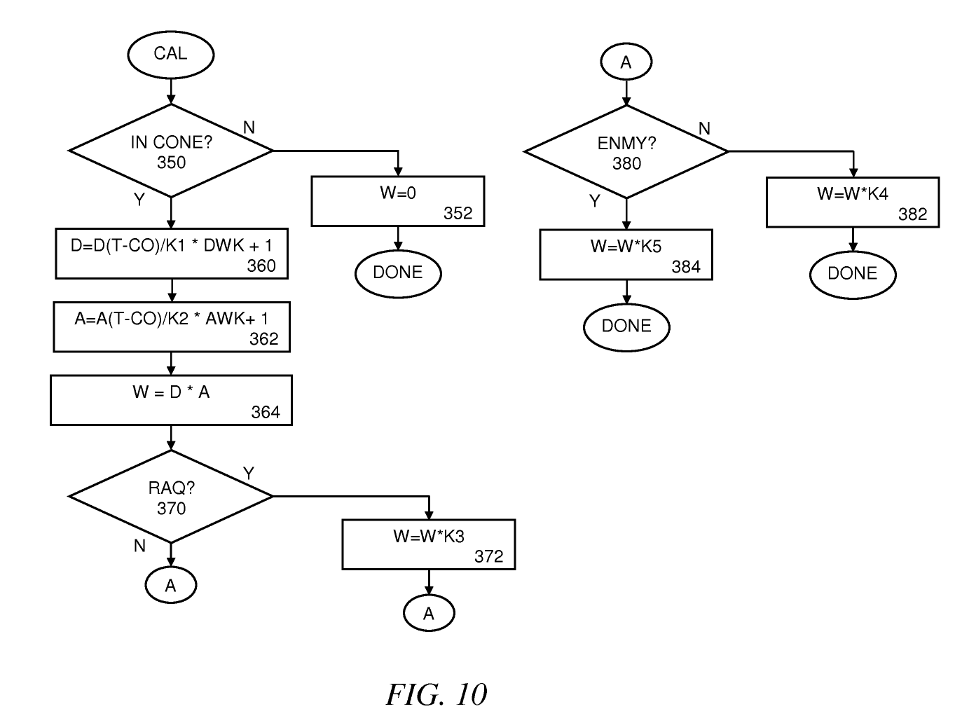

A first target of the targets 20/22/24/25 is selected 300 as the current target. In a loop, the weight of the current target is calculated 302 (see FIG. 10) and if the current target is not the last target 304, a next target is found and saved as the current target 306 and the loop continues.

If the current target was the last target 304, a test is performed 310 to determine if a trigger has been invoked (e.g. a hand gesture or pressing of a trigger button on a controller 224). If no trigger has been invoked 310, the above steps are repeated. In some embodiments, a delay is taken before the above steps are repeated (not shown).

If a trigger has been invoked 310, the targets 20/22/24/25 are then scanned to determine which target 20/22/24/25 has the highest weight and, therefore, is the best intended target (at least calculated as the best intended target). To determine which target 20/22/24/25 has the highest weight, again the first target of the targets 20/22/24/25 is selected as the current target and a maximum weight variable is initialized 312. In a loop, if the weight of the current target is greater than the maximum weight found 314, a target pointer, T, is set to the current target and the maximum weight is set to the weight of the current target 316. The loop continues and if the current target is not the last target 318, the next target is selected 320 and the loop resumes.

If the current target is the last target 318, the target last saved in the target pointer, T, is operated upon 322. For example, a round of ammunition is fired at the target, T, or a spell is cast at the target, T. As is known in the industry, there is not necessarily certainty that firing a round of ammunition or casting a spell at/on a target will have devastating effect on the target, but in the scenario described, the player will likely be targeting the most advantageous target, T. It is anticipated that a visual representation of the firing/casting be portrayed on the players display 232

Referring to FIG. 10, a second flow chart of an exemplary gaming system target selection is shown. Again, note that this is an exemplary program flow and there are many other program flows anticipated that will achieve similar results in similar or different manners.

In this flow, a weight is calculated for one specific target, T. To start, it is determined 350 if the target, T, is in the cone 40. For example, the coordinates of the target, T, (e.g. X-Y or X-Y-Z coordinates) are examined to determine 350 if the coordinates of the target, T, are within the cone 40. If it is determined 350 that the target, T, is not within the cone 40, the weight of that target, T, is set to zero (or another value representing a non-eligible target) and the calculation is complete 352.

If it is determined 350 that the target, T, is within the cone 40, a series of calculations are made based upon location of the player (origin of the cone 42) and location of the current target, T. Although many variables are anticipated to be used to calculate the weight, for exemplary reasons, location and angle are shown here within. Other considerations are equally anticipated such as direction of movement of the current target, T, speed of movement of the current target, T, type of target, T, direction of movement of the player, speed of movement of the player, experience of the player, virtual time of the game (e.g. time since beginning or daytime/nighttime), interference from other objects, etc.

In the example shown, a distance weight, D, is calculated 360 by determining the distance between the current target, T, and the cone origin 42, CO, then dividing this distance by a constant, K1, and adding 1. The constant, K1, is preferably the depth of the cone 40 and, therefore, the distance between the current target, T, and the cone origin 42 must be less than the constant, K1. Therefore, dividing the distance (between the current target, T, and the cone origin 42, CO) by the constant, K1, results in a value between zero and one. In some embodiments, the resulting distance weight value is multiplied by a distance weight constant (DWK) to provide more or less bias to the distance between the target and the cone origin (e.g. between the target and the player). If the optional distance weight constant (DWK) is a value between zero and 1, then by adding one to the distance value results in a normalized distance value, D, of from one to two.

An angle weight, A, is calculated 362 by determining the angle between the current target, T, and the cone origin 40, CO, then dividing this angle by a constant, K2, and adding 1. The constant, K2, is preferably the angle of the cone 40 and, therefore, the angle between the current target, T, and the cone origin 42 must be less than the constant, K2. Therefore, dividing the angle (between the current target, T, and the cone origin 42, CO) by the constant, K2, results in a value between zero and one. In some embodiments, the resulting angle weight value is multiplied by a angle weight constant (AWK) to provide more or less bias to the angle between the target and the cone center (e.g. between the target and direct view sight of the player). If the optional angle weight constant (AWK) is a value between zero and 1, then by adding one to the angle weight value results in an angle value, A, of from one to two.

Next a starting value for the calculated weigh, W, is calculated 364 by multiplying the distance weight, D, by the angle weight, A. By selecting constants K1 and K2 as above, the values for each of the distance weight, D, and the angle weight, A, are both from one to two, so the calculated weight, W, will be from one (both the distance weight, D, and the angle weight, A have the value 1) to four (both the distance weight, D, and the angle weight, A have the value 2).

Next, a test 370 to determine if the current target, T, was a recently acquired target is performed. There are many ways anticipated to determine if the current target, T, was a recently acquired target such as storing a flag or value in the target data structure 520/522 indicating, for example, the game virtual time at which that target was last acquired (last acquired time) or last assaulted, or last fired upon. In such, to determine if the current target, T, was a recently acquired target, the current game virtual time is compared to the last acquired time of the current target, T, and if less than a certain threshold value, it is deemed that the current target, T, was recently acquired. In another example, each time a firing operation 322 (see FIG. 9) is performed, the target which was fired upon is recorded in a global variable as the last acquired target, and only that target will be deemed the recently acquired target until another target is fired upon. If the test 370 determines that the current target, T, was a recently acquired target, the calculated weight, W, is multiplied 372 by a third constant, K3, to give more (or less if K3<1) weight to a target that was recently acted upon. For example, if the third constant, K3, has the value of 3 and the current target, T, was recently acquired, then the new calculated weigh, W, is 3 times the calculated weight, W, based upon angle and distance.

In some embodiments, a test 380 is performed to determine if the current target, T, is an enemy. For example, some targets are enemy creatures, enemy vehicles, enemy animals, etc., while other objects are neutral or allied objects such as buildings, walls, trees, co-players, etc. If the test 380 determines that the current target, T, is an enemy, the current weight, W, is multiplied 382 by a fourth constant, K4, for example, 1.5, giving more weight to enemy objects. If the test 380 determines that the current target, T, is not an enemy, the current weight, W, is multiplied 384 by a fifth constant, K5, for example, 0.5, giving less weight to friendly or neutral objects.

Again, this is one exemplary set of algorithms for determining which target 20/22/24/25 is the intended target and in other embodiments, more or less characteristics are examined to select an appropriate target from all available targets 20/22/24/25. Examples of these characteristics include, but are not limited to, health of the target (e.g. already killed), speed of the target, direction of movement of the target, power of the target, aggression factor of the target, phase of the current game, time of the current game, simulated time of day (e.g. nocturnal targets may get less weight during the daytime), direction of movement of the player, speed of movement of the player, direction/speed of movement of the player with respect to the target (e.g. following the target or fleeing from the target), players weapon (e.g. certain targets not affected by certain weapons are given lower weight), etc. In some embodiments, the success rate of prior smart targeting feeds back into the weight calculations such that, if the game previously made several wrong choices, some or all of the constants used in the calculations are modified to make improvements in the success rate, then the success rate is further monitored to determine if the changes made a positive difference.

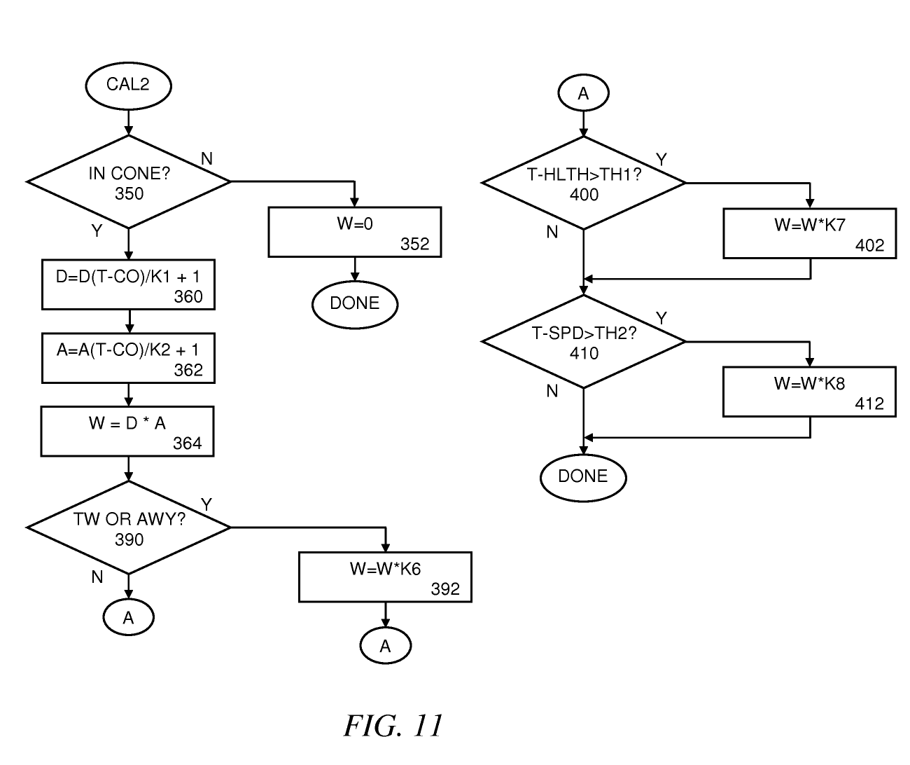

Referring to FIG. 11, a third flow chart of an exemplary gaming system target selection is shown. Again, note that this is an exemplary program flow and there are many other program flows anticipated that will achieve similar results in similar or different manners. This is one of the many alternate ways to calculate the weight of each specific target, T.

In this alternate flow, a weight is calculated for one specific target, T, using a different algorithm than used with FIG. 10. As with the algorithm of FIG. 10, it is determined 350 if the target, T, is in the cone 40. For example, the coordinates of the target, T, (e.g. X-Y or X-Y-Z coordinates) are examined to determine 350 if the coordinates of the target, T, are within the cone 40. If it is determined 350 that the target, T, is not within the cone 40, the weight of that target, T, is set 352 to zero (or another value representing a non-eligible target) and the calculation is complete.

If it is determined 350 that the target, T, is within the cone 40, a series of calculations are made based upon locations of the player (origin of the cone 42) and locations of the current target, T. Although many variables are anticipated to be used to calculate the weight, for exemplary reasons, location and angle are shown.

Also in the example shown, a distance weight, D, is calculated 360 by determining the distance between the current target, T, and the cone origin 42, CO, then dividing this distance by a constant, K1, and adding 1. The constant, K1, is preferably the depth of the cone 40 and, therefore, the distance between the current target, T, and the cone origin 42 must be less than the constant, K1. Therefore, dividing the distance (between the current target, T, and the cone origin 42, CO) by the constant, K1, results in a value of from zero to one, and by adding one to that value results in a distance value, D, of from one to two.

An angle weight, A, is then calculated 362 by determining the angle between the current target, T, and the cone origin 40, CO, then dividing this angle by a constant, K2, and adding 1. The constant, K2, is preferably the angle of the cone 40 and, therefore, the angle between the current target, T, and the cone origin 42 must be less than the constant, K2. Therefore, dividing the angle (between the current target, T, and the cone origin 42, CO) by the constant, K2, results in a value of from zero to one, and by adding one to that value results in an angle value, A, of from one to two.

Next, a starting value for the calculated weigh, W, is calculated 364 by multiplying the distance weight, D, by the angle weight, A. By selecting constants K1 and K2 as above, the values for each of the distance weight, D, and the angle weight, A, are both from one to two, so the calculated weight, W, will be from one (both the distance weight, D, and the angle weight, A have the value 1) to four (both the distance weight, D, and the angle weight, A have the value 2).

Next, a test 390 is performed to determine if the current target, T, is moving towards or away from the player (cone origin 42). There are many ways anticipated to determine of the movement of the current target, T such as storing a directional value in the target data structure 520/522 indicating, for example, X and Y direction (both positive and negative). Then, to determine if the current target, T, is moving toward/away from the player, the position of the current target, T, position of the player (cone origin 42) and the X and Y direction of the current target, T, are examined to determine movement of the target, T, with respect to the player. If the test 390 determines that the current target, T, is moving toward the player (e.g. chasing the player) or away from the player (e.g. being pursued by the player), the calculated weight, W, is multiplied 392 by a sixth constant, K6, to give more weight to a target that is moving toward or away from the player. For example, if the sixth constant, K6, have the value of 2 and the current target, T, is moving towards the player, then the new calculated weigh, W, is 2 times the previously calculated weight, W.

Further in this embodiment, a test 400 is performed to determine if a health value of the current target, T, is greater than a threshold, TH1. For example, in some embodiments, a health value is stored in the target data structure 520/522 indicating, for example, zero meaning the current target, T, is dead and one meaning the current target is very healthy and values between zero and one being various degrees of health. Therefore, in this example, the test 400 examines the health value of the current target, T, by comparing the health value to a threshold, TH1. For example, the test 400 examines the health value of the current target, T, by comparing the health value to a threshold, TH1, of 0.8. If the test 400 determines that the current target, T, is healthy (the health value is >0.8), the current weight, W, is multiplied 402 by a seventh constant, K7, for example, 4, giving more weight to healthy targets.

Also in this embodiment, a test 410 is performed to determine if the speed of the current target, T, is greater than a second threshold, TH2. For example, in some embodiments, a speed value is stored in the target data structure 520/522 indicating, for example, the speed of the target 20/22 in virtual game units per virtual game time intervals. In this example, the test 410 examines the speed value of the current target, T, by comparing the speed value to a threshold, TH2. For example, the test 410 examines the speed value of the current target, T, by comparing the speed value to a threshold, TH2, of 10 distance units per virtual game tick. If the test 410 determines that the current target, T, is moving fast (the speed value is >10), the current weight, W, is multiplied 412 by an eighth constant, K8, for example, 8, giving more weight to faster targets.

Again, the above algorithms are exemplary algorithms for determining which target 20/22/24/25 is the intended target and in other embodiments, more or less characteristics are examined to select an appropriate target from all available targets 20/22/24/25. Examples of these characteristics include, but are not limited to, health of the target (e.g. already killed), speed of the target, direction of movement of the target, power of the target, aggression factor of the target, phase of the current game, time of the current game, simulated time of day (e.g. nocturnal targets may get less weight during the daytime), direction of movement of the player, speed of movement of the player, direction/speed of movement of the player with respect to the target (e.g. following the target or fleeing from the target), players weapon (e.g. certain targets not affected by certain weapons are given lower weight), etc. In some embodiments, the success rate of prior smart targeting feeds back into the weight calculations such that, if the game previously made several wrong choices, some or all of the constants used in the calculations are modified to make improvements in the success rate, then the success rate is further monitored to determine if the changes made a positive difference.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for smart targeting in a video game operated in a virtual game space with a virtual viewport defining a local of a player of the video game, at least a portion of the virtual viewport displayed on a display device, the method comprising:
a) providing at least two game characters within the virtual game space;
b) providing a player virtual location within the virtual viewport;
c) displaying a depiction of at least a portion of the virtual viewport on the display device;
d) for each of the at least two game characters that are located within the virtual viewport, calculating a target weight for the each of the at least two game characters that are located within the virtual viewport and associating the target weight with the each of the at least two game characters located within the virtual viewport;
e) determining which of the each of the at least two game characters that are located within the virtual viewport has the greatest weight;
f) checking to see if a trigger has been activated and if the trigger has not been activated, and repeating steps c-f; and
g) if the trigger has been activated, initiating firing at the game character that is located within the virtual viewport having the greatest target weight, and repeating steps c-g.

2. The method of claim 1, wherein the trigger is activated by a trigger button.

3. The method of claim 1, wherein the trigger is activated by a gesture.

4. The method of claim 1, wherein the step of calculating a target weight includes calculating a virtual distance from the each of the at least two game characters to the player virtual location.

5. The method of claim 1, wherein the step of calculating a target weight includes calculating an angle between the each of the at least two game characters and the player virtual location.

6. The method of claim 1, wherein the step of calculating a target weight includes determining if the each of the at least two game characters is an enemy.

7. The method of claim 1, wherein the step of calculating a target weight includes determining if the each of the at least two game characters was recently a target.

8. The method of claim 1, wherein the step of initiating firing includes depicting a projectile launched from the player virtual location within the virtual viewport to a position of the game character that is located within the virtual viewport having the greatest target weight.

9. The method of claim 1, wherein the step of initiating firing includes depicting a spell launched from the player virtual location within the virtual viewport to a position of the game character that is located within the virtual viewport having the greatest target weight.

10. A method for smart targeting in a video game operated in a virtual game space with a virtual viewport defining a local of a player of the video game, at least a portion of the virtual viewport displayed on a display device, the method comprising:
a) providing at least two game characters within the virtual game space;
b) providing a player virtual location within the virtual viewport;
c) providing a virtual area of focus within the virtual viewport;
d) displaying a depiction of at least a portion of the virtual viewport on the display device;
e) for each of the at least two game characters that are located within the virtual area of focus, calculating a target weight for the each of the at least two game characters that are located within the virtual area of focus and associating the target weight with the each of the at least two game characters located within the virtual area of focus;
f) determining which of the each of the at least two game characters that are located within the virtual area of focus has the greatest weight;
g) checking to see if a trigger has been activated and if the trigger has not been activated, and repeating steps c-g; and
h) if the trigger has been activated, initiating firing at the game character that is located within the virtual area of focus having the greatest target weight, and repeating steps c-h.

11. The method of claim 10, wherein the virtual area of focus is a conical area emanating from the player virtual location.

12. The method of claim 10, wherein the virtual area of focus is a triangular area emanating from the player virtual location.

13. The method of claim 10, wherein the step of calculating a target weight includes calculating a virtual distance from the each of the at least two game characters to the player virtual location.

14. The method of claim 10, wherein the step of calculating a target weight includes calculating an angle between the each of the at least two game characters and the player virtual location.

15. The method of claim 10, wherein the step of calculating a target weight includes determining if the each of the at least two game characters is an enemy.

16. The method of claim 10, wherein the step of calculating a target weight includes determining if the each of the at least two game characters was recently a target.

17. A computer-readable storage medium having embodied thereon a video game program operated in a virtual game space with a virtual viewport defining a local of a player of the video game, at least a portion of the virtual viewport displayed on a display device, said video game program executable by a computing device for performing steps of a method for smart targeting in said video game, the steps comprising:
a) providing at least two game characters within the virtual game space;
b) providing a player virtual location within the virtual viewport;
c) providing a virtual area of focus within the virtual viewport;
d) displaying a depiction of at least a portion of the virtual viewport on the display device;
e) for each of the at least two game characters that are located within the virtual area of focus, calculating a target weight for the each of the at least two game characters that are located within the virtual area of focus and associating the target weight with the each of the at least two game characters located within the virtual area of focus;
f) determining which of the each of the at least two game characters that are located within the virtual area of focus has the greatest weight;
g) checking to see if a trigger has been activated and if the trigger has not been activated, and repeating steps c-g; and
h) if the trigger has been activated, initiating firing at the game character that is located within the virtual area of focus having the greatest target weight, and repeating steps c-h.

18. The method of claim 17, wherein the virtual area of focus is a conical area emanating from the player virtual location.

19. The method of claim 17, wherein the virtual area of focus is a triangular area emanating from the player virtual location.

20. The method of claim 17, wherein the step of calculating a target weight includes calculating a virtual distance from the each of the at least two game characters to the player virtual location.

21. The method of claim 17, wherein the step of calculating a target weight includes calculating an angle between the each of the at least two game characters and the player virtual location.

22. The method of claim 17, wherein the step of calculating a target weight includes determining if the each of the at least two game characters is an enemy.

23. The method of claim 17, wherein the step of calculating a target weight includes determining if the each of the at least two game characters was recently a target.

24. A gaming system comprising:
a computer;
a display operatively coupled to the computer;
a trigger operatively coupled to the computer;
a storage operatively interfaced to the computer;
a virtual game space defined within the storage;
a plurality of game characters defined within the storage at game character locations within the virtual game space;
a viewport being a subset of the virtual game space defined within the storage at a location within the virtual game space; and
software instructions stored within the storage and executed by the computer, the software instructions operable to determine an intended target from the plurality of game characters, to detect activation of the trigger, and, responsive to activation of the trigger, to fire at the intended target.

25. The gaming system of claim 24, wherein the intended target is required to be within the viewport.

26. The gaming system of claim 24, wherein the intended target is required to be within a virtual area of focus, the virtual area of focus being a subset of an area of the viewport.

27. The gaming system of claim 24, wherein the software instructions operable to determine the intended target from the plurality of game characters considers, for each game characters in the plurality of game characters, two or more of the list consisting of a distance within the virtual game space between the each game character and the player, an angle within the virtual game space between the each character and the player, whether the each character is an enemy, whether the each game character was recently the intended target, a direction of movement of the each game character, a speed of the each game character, a direction of movement of the player within the virtual game space, a speed of movement of the player within the virtual game space, and a location of each game character within the viewport.
